(19) United States
(12) Patent Application Publication
(10) Pub. No.: US 2024/0395172 A1
(43) Pub. Date: Nov. 28, 2024

(54) ADHESIVE ELEMENT

(71) Applicant: Hueck Folien Gesellschaft m.b.H., Baumgartenberg (AT)

(72) Inventors: Anita FUCHSBAUER, Linz (AT); Martin EGGINGER, Linz (AT); Stephan TRASSL, Baumgartenberg (AT); Georg AIGNER, Ennsdorf (AT)

(21) Appl. No.: 18/687,903

(22) PCT Filed: Aug. 29, 2022
(86) PCT No.: PCT/AT2022/060295

§ 371 Date: Feb. 29, 2024

(30) Foreign Application Priority Data
Aug. 30, 2021 (EP) 21193859.2

(51) Int. Cl. G09F 3/10; C09J 7/25; G09F 3/00

(52) U.S. Cl. CPC G09F 3/10; C09J 7/255; G09F 3/0292; C09J 2203/338

(57) ABSTRACT

An adhesive element comprises a carrier substrate and an adhesive layer arranged on the carrier substrate. The adhesive element comprises at least one recycled material, and/or at least one material made of renewable raw materials, and/or at least one biologically degradable and/or marine-degradable material.

### RELATED APPLICATIONS

This is a national stage under 35 U.S.C. § 371 of International Application No. PCT/AT2022/060295, filed Aug. 29, 2022, which claims priority of European Patent Application No. 21193859.2, filed Aug. 30, 2021.

### TECHNICAL FIELD

The field of this disclosure relates to an adhesive element comprising a carrier substrate and an adhesive layer arranged on the carrier substrate.

### BACKGROUND

Adhesive elements may be labels, security labels, adhesive tapes, security tapes or self-adhesive graphic film elements. Functional labels are also known, which may be used to connect objects, for example, or which may have barrier properties. Such adhesive elements are used for a wide range of products in various industries and areas of application. While labels, adhesive tapes and the like are usually primarily used to decorate or mark products, objects or packaging, security labels, security adhesive tapes or graphic film elements also have a quality assurance or authentication function.

In order to fulfill all these tasks, adhesive elements usually consist of a number of layers or films made of different materials, but are usually not disposed of separately by an end user, not least because of their adhesive properties. This often results in contamination of the disposal fraction when disposing of items containing adhesive elements.

### SUMMARY

A need remains for adhesive elements that overcome the remaining disadvantages of the prior art and to further improve the sustainability of adhesive elements, while at the same time not impairing the required technical properties of the adhesive elements.

It should be noted that the term “in particular” in this document is understood to mean a possible more specific embodiment or more detailed specification of an object, but does not necessarily have to represent a mandatory, preferred embodiment thereof or a mandatory approach.

As used herein, the terms “comprising”, “has”, “having”, “includes”, “including”, “contains”, “containing” and any variations thereof are intended to cover non-exclusive inclusion.

At this point, it should also be noted that the term “layer” in the context of the present disclosure may describe both a single layer and a composite or a layering of several layers. This may involve several layers of the same type, for example, but also several different types of layers. The same applies to the term “film”.

The present disclosure relates to an adhesive element in which it is provided that the adhesive element comprises at least one recycled material, and/or at least one material made of renewable raw materials, and/or at least one biologically degradable and/or marine-degradable material.

In the present context, the term “adhesive element” refers in particular to labels, security labels, adhesive tapes, security adhesive tapes or self-adhesive graphic film elements. Adhesive elements usually comprise a carrier substrate or a carrier or base film, which serves as a carrier material for security elements, various functional layers and print layers, for example. By means of the adhesive layer, the adhesive element can be attached to the surface of an object permanently or, if necessary, detachably. The adhesive layer may be a self-adhesive layer or a hot-melt adhesive layer, for example. If the adhesive layer is configured as a hot-melt adhesive layer, either the adhesive may be applied to or incorporated into a melt, or the adhesive element may be applied to the object under thermal influence.

The at least one recycled material may be any type of recyclable material or material composition. For example, this includes all types of plastics, as well as metals, metal alloys or metal compounds. Various chemical compositions may also be recyclable and thus be included in the adhesive element as recycled material. Because adhesive elements are usually made up of several layers, films or components, it may be useful if different types of recycled material are used in these individual components.

It is conceivable that the at least one recycled material and/or the at least one material made of renewable raw materials and/or the at least one biologically degradable and/or marine-degradable material is contained in the adhesive layer, in the carrier substrate and/or in a further component, layer or film applied to the carrier substrate.

This improves the sustainability of the adhesive element and its entire product life cycle, as the use of at least one recycled material enables the sustainable production. By using at least one recycled material in the production of adhesive elements, means are created which meet the increasing ecological requirements and at the same time guarantee the corresponding necessary counterfeit protection.

The sustainable life cycle of the adhesive element may be further improved by the alternative or additional use of at least one material made of renewable raw materials and/or biologically degradable and/or marine-degradable material. It may also make a valuable contribution to environmental protection. The material made of renewable raw materials or the biologically degradable and/or marine-degradable material may be a material other than the recycled material. However, it is particularly sustainable if the material made of renewable raw materials or the biologically degradable and/or marine-degradable material is the same material as the recycled material.

Renewable raw materials may be used for the synthesis of the corresponding chemical raw materials. Plastics may, for example, be divided into so-called drop-ins and new bio-based plastics. Drop-ins are bioplastics that are based on renewable raw materials and for which existing processes and value chains remain essentially unchanged during processing, use and recycling (e.g. PA, PU, PE, PP, PET, etc.). New bio-based plastics are replacing fossil-based plastics (e.g. thermoplastic starch (TPS), polylactic acid (PLA), cellulose- or lignin-based plastics, etc.), although their use as an alternative to fossil-based plastics is not yet fully established for all bio-based plastics.

Biologically degradable plastics consist of polymers that can be decomposed by microorganisms under certain conditions. The term “marine-degradable” refers to the possibility of natural degradation under marine environmental conditions. Biologically degradable and bio-based plastics include polyhydroxyalkanoates (PHA) and thermoplastic starch (TPS), for example. Biologically degradable plastics include, for example, polylactic acid (PLA), polycaprolactone (PCL), polybutylene succinate (PBS) and polybutylene adipate terephthalate (PBAT).

By using sustainably produced raw films and/or raw materials, for example as coating materials, corresponding adhesive elements or labels can be produced sustainably without impairing the required technical properties such as appearance, adhesion of the adhesive layer to surfaces, printability of the carrier substrate or a layer applied to the carrier substrate, or at least without impairing the required technical properties in a way that is unacceptable for the application.

According to an advantageous further embodiment, it may be provided that the adhesive element comprises at least one security feature, or at least one security element with at least one security feature. By providing security features and/or security elements, adhesive labels may be used to authenticate various objects, products and packaging in order to prevent counterfeiting or at least make it more difficult. This allows an end user or end customer to reliably distinguish between legally and illegally traded goods.

The security feature may be configured in a security element, which in turn may be a component of adhesive elements. Security features (e.g. magnetic coding, embossing varnish layers, metallized layers, color shifting materials or layers, etc.) increase counterfeit protection and serve to certify the authenticity of security elements, adhesive elements or objects provided with adhesive elements. The security element may also be a so-called VOID label, for example, which may be used to indicate tampering attempts on objects and packaging. Essentially, VOID labels or adhesive elements with tamper evidence comprise a carrier substrate, in particular a carrier film, wherein the carrier film advantageously comprises a plastic or consists of plastic, and an adhesive layer arranged on the carrier substrate, preferably a self-adhesive layer. A partial separation layer is configured on the side facing away from the visible side of the VOID label, which is shaped as a letter, number, character, symbol or part of an image when viewed from the visible side. A layer, for example a paint layer or a metal layer, may be configured under the partial separation layer or the partial separation layer may be embedded in this layer. The adhesive layer in turn may be provided underneath the layer.

Security elements may be made up of one or more layers or one or more films. The term “layer” may describe a single layer as well as a composite or a layering of several layers. These may be several layers of the same type, for example, but also several different layers. It should be noted at this point that one or more intermediate layers may be arranged between the layers described in this document. It is therefore not absolutely necessary for the layers described to contact each other. It should also be noted that the term “layer” in this document is to be understood as meaning that a layer may also be made up of several sub-layers. The same applies to the term “film”. According to an advantageous further embodiment, it may be provided that the security feature and/or the security element comprises the at least one recycled material, and/or the at least one material made of renewable raw materials, and/or the at least one biologically degradable and/or marine-degradable material.

Furthermore, it may be useful if the adhesive element comprises at least 10%, preferably at least 20%, particularly preferably at least 30%, in particular at least 50% of the at least one recycled material and/or the at least one material made of renewable raw materials and/or the at least one biologically degradable and/or marine-degradable material, or if the security element comprises at least 10%, preferably at least 20%, particularly preferably at least 30%, in particular at least 50% of several recycled materials and/or several materials made of renewable raw materials and/or several biologically degradable and/or marine-degradable materials.

Furthermore, it may be provided that the at least one recycled material, and/or the at least one material made of renewable raw materials, and/or the at least one biologically degradable and/or marine-degradable material is a cellulose fiber free material.

In addition, it may be provided that the adhesive element, in particular the carrier substrate, is configured with at least one plastic film or as a plastic film, which plastic film comprises the at least one recycled material and/or the at least one material made of renewable raw materials and/or the at least one biologically degradable and/or marine-degradable material. If the adhesive element is configured with at least one security element or with at least one security feature, it may also be useful if these are applied to a carrier substrate configured as a plastic film, i.e. to a polymer substrate, by means of one or more layers. The plastic film may, for example, be a polymer carrier film or a polymer substrate to which the at least one security feature and, if necessary, other layers such as protective varnishes may be applied.

An embodiment according to which it may be provided that the at least one recycled material and/or the at least one biologically degradable and/or marine-degradable material comprises a chemically recycled plastic and/or a mechanically recycled plastic, in particular comprises a translucent recycled plastic, is also advantageous, wherein the at least one recycled material and/or the at least one biologically degradable and/or marine-degradable material preferably comprises at least one material from the group consisting of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC) ethylene tetrafluoroethylene (ETFE), polytetrafluoroethylene (PTFE), polyvinyl fluoride (PVF), polyvinylidene fluoride (PVDF), ethylene tetrafluoroethylene hexafluoropropylene fluorterpolymer (EFEP), cellulose- or lignin-based plastics, polyhydroxyalkanoates (PHA), thermoplastic starch (TPS), polylactic acid (PLA), polycaprolactone (PCL), polybutylene succinate (PBS), and polybutylene adipate terephthalate (PBAT) and/or mixtures and/or co-polymers and/or composites of these materials or is made from at least one of these materials.

Chemical recycling refers to methods in which plastics are broken down into shorter molecules by thermal or energy effects or by chemical processes so that they can be reused in subsequent manufacturing processes such as polymerization. So-called PCR plastics (“post consumer recycling”), PIR plastics (“post industrial recycling”) and CCU plastics (“carbon capture and utilization”), for example, may be chemically recycled.

For the production of PCR plastics, plastic waste is converted back into raw materials or monomers for the production of new raw materials after end use and used to produce polymer films or paint components, for example. For example, PET, PE and PP films may be sourced with a certain proportion of PCR raw materials. The production of PIR plastics is generally similar to the production of PCR plastics. However, industrial waste is used here, which is generally less contaminated or more homogeneous. To produce CCU plastics, carbon dioxide is separated from exhaust gas streams or from the air and then serves as a raw material or component for the production of energy sources such as methane or methanol or for the production of chemical raw materials such as polycarbonates or PVC. Both chemical and biological methods with algae or microorganisms are known for this purpose.

Mechanically recycled plastic may be recovered in the course of material recycling. Among other things, PCR plastics and PIR plastics may be mechanically recycled. Plastic waste is sorted according to the respective type of plastic and processed into recyclates, which can be used as a starting material for new products and thus replace plastics made from new materials. This type of recycling preserves the original chemical structure of the polymers.

According to a further development, it is conceivable that the at least one recycled material and/or the at least one biologically degradable and/or marine-degradable material is at least one recycled metallic material, in particular selected from the group consisting of silver, copper, aluminum, gold, platinum, niobium, tin, or nickel, titanium, vanadium, chromium, cobalt and palladium or alloys of these materials, in particular cobalt-nickel alloys, and/or at least one highly refractive dielectric material with a refractive index of greater than 1.65, in particular selected from the group consisting of zinc sulphide (ZnS), zinc oxide (ZnO), titanium dioxide (TiO2), carbon (C), indium oxide (In2O3), indium tin oxide (ITO), tantalum pentoxide (Ta2O5), cerium oxide (CeO2), yttrium oxide (Y2O3), europium oxide (Eu2O3), iron oxides such as iron (II, III) oxide (Fe3O4) and iron (III) oxide (Fe2O3), hafnium nitride (HfN), hafnium carbide (HfC), hafnium oxide (HfO2), lanthanum oxide (La2O3), magnesium oxide (MgO), neodymium oxide (Nd2O3), praseodymium oxide (Pr6O11), samarium oxide (Sm2O3), antimony trioxide (Sb2O3), silicon carbide (SiC), silicon nitride (Si3N4), silicon monoxide (SiO), selenium trioxide (Se2O3), tin oxide (SnO2), tungsten trioxide (WO3), highly refractive organic monomers and/or highly refractive organic polymers or layers of metal oxides, such as non-stoichiometric aluminum oxide, copper oxides, or chromium oxides and/or is produced from at least one recycled metallic material from printing inks or varnishes with metallic pigments, in particular selected from the group of aluminum, silver, copper, gold, platinum, niobium, tin, or from nickel, titanium, vanadium, chromium, cobalt and palladium or alloys of these materials, in particular cobalt-nickel alloys.

The use of sustainable raw materials for various coating materials (e.g. paint components, metals such as aluminum from recycled aluminum, etc.) has made it possible to produce sustainable adhesive elements.

Security features increase counterfeit protection and serve to certify the authenticity of adhesive elements. It may be expedient if the at least one security feature is formed by an embossed layer, a partially metallized layer, a fluorescent layer, a printed layer, a magnetic coding and/or an optically variable and/or optically effective feature, in particular by a hologram and/or a color shifting coating, for example a coating comprising at least one color shifting thin layer element, and/or by features that are optically recognizable in transmission or reflection, machine-readable features (i.e. a magnetic coding) and/or by electromagnetic wave-absorbing and/or re-emitting substances or features. The at least one security feature may also be formed by luminescent or phosphorescent coatings.

Optically variable and/or optically effective security features also include, for example, optically effective relief structures, in particular mirrors, diffraction gratings, holograms, kinoforms, asymmetric diffraction structures, matte structures, in particular anisotropic matte structures, blaze gratings, zero-order diffraction structures, Fresnel-like free-form surfaces, plasmonic structures, reflective structures, in particular micromirror arrangements, light-refracting or focusing structures, in particular microlens arrangements, volume holograms and color shifting effects (based on thin-film elements, liquid crystals, color shifting pigments, etc.).

In addition, it may be provided that the adhesive element is configured as a self-adhesive adhesive element, and that the adhesive element, in particular the carrier substrate or the plastic film, comprises a PET film, which PET film is produced with at least 30% PCR material, preferably with at least 50% PCR material.

It is also conceivable that the plastic film is configured as a metallized PE film, which metallized PE film has a metallic layer, wherein the metallized PE film is produced with at least 20% PCR material, preferably with at least 50% PCR content. Such metallized films have become known to those skilled in the art, for example from WO 2020/221753 A1, and preferably have the following layers in the specified order: a carrier substrate made of a plastic film, a varnish layer as an adhesion promoter layer, a metallic layer applied, in particular directly, to the varnish layer, and optionally a cover layer.

In addition, the plastic film may be configured as a metallized PE film, which metallized PE film has a metallic layer, wherein the metallized PE film is produced with PCR material and PIR material in a ratio of at least substantially 1:1. It may also be advantageous if the metallized PE film is made with 100% or at least almost 100% PCR material.

According to a further embodiment, it may be provided that the adhesive element is an adhesive element with tamper evidence, which is produced with at least 70% PCR material, preferably with at least 90% PCR content. Generic adhesive elements are often referred to as VOID labels and are used to indicate tampering attempts on objects and packaging. In particular, VOID labels may be used to provide relatively inexpensive protection against counterfeiting, or to provide simple proof of authenticity or proof of quality. As soon as the VOID label is removed from the substrate, a security feature appears on the label surface that was previously invisible or invisible when the label was attached. These are mostly lettering, pictures, patterns and the like.

### BRIEF DESCRIPTION OF THE DRAWINGS

For the purpose of better understanding of the invention, this will be elucidated in more detail by means of the figures below.

These show respectively in a very simplified schematic representation:

FIG. 1 an adhesive element with tamper evidence applied to the surface of an object in sectional view,

FIG. 2 the adhesive element from FIG. 1 during detachment from the surface of the object, wherein a part of the adhesive element remains on the surface,

FIG. 3 the adhesive element from FIG. 1 during residue-free detachment from the surface of the object,

FIG. 4 another exemplary embodiment of an adhesive element.

### DETAILED DESCRIPTION OF EXEMPLARY EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows an adhesive element 1 with tamper evidence in sectional view, which is applied to the surface 11 of an object 10. Generic adhesive elements 1 are often referred to as VOID labels and are used to indicate tampering attempts on objects 10 and packaging.

The adhesive element 1 according to the exemplary embodiment comprises essentially a carrier substrate 2, in particular a carrier film or a plastic film 7, and an adhesive layer 3 arranged on the carrier substrate 2, preferably a self-adhesive adhesive layer. The adhesive element 1 comprises at least one recycled material 4, and/or at least one material made from renewable raw materials, and/or at least one biologically degradable and/or marine-degradable material 5. On the side facing away from the visible side 12 of the adhesive element 1, a security element 6 is configured in the form of a partial separation layer 15. This partial separation layer 15 may be designed as a letter, number, character, symbol or part of an image when viewed from the visible side 12. Beneath the partial separation layer 15, a layer 16 may be configured, or the partial separation layer 15 may be embedded in the layer 16. Beneath the layer 16 in turn may be provided an adhesive layer 3 according to the example in FIG. 1.

The layer 16 may be an ink layer, in particular a printed ink layer. The ink layer may be configured partially and/or multicolored. However, it is also possible that the layer 16 is configured as a metal layer 9.

As soon as the adhesive element 1 or the VOID label is detached from the surface 11 of the object 10, a security feature “appears” on the label surface that was previously or invisible in the affixed state, or lettering, images, patterns and the like formed by the partial release layer 15 become visible.

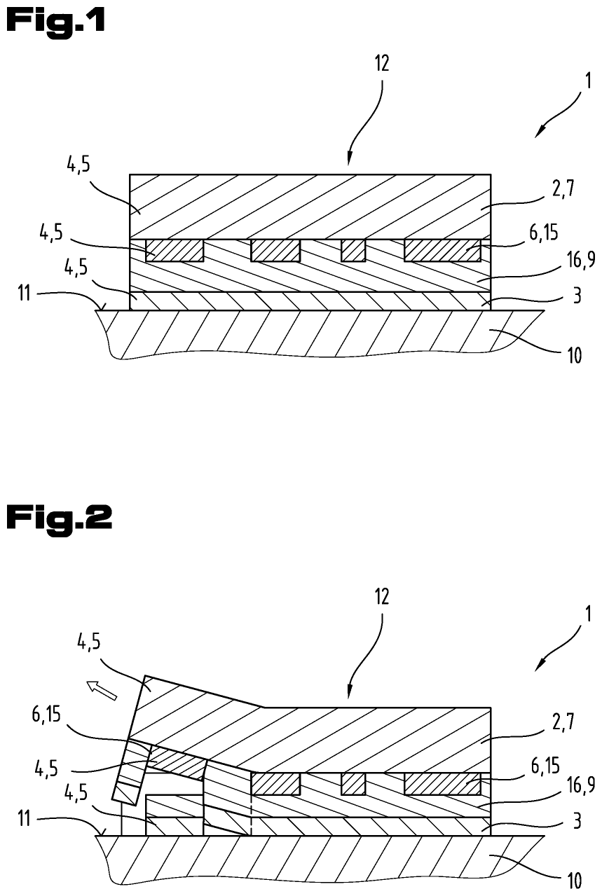

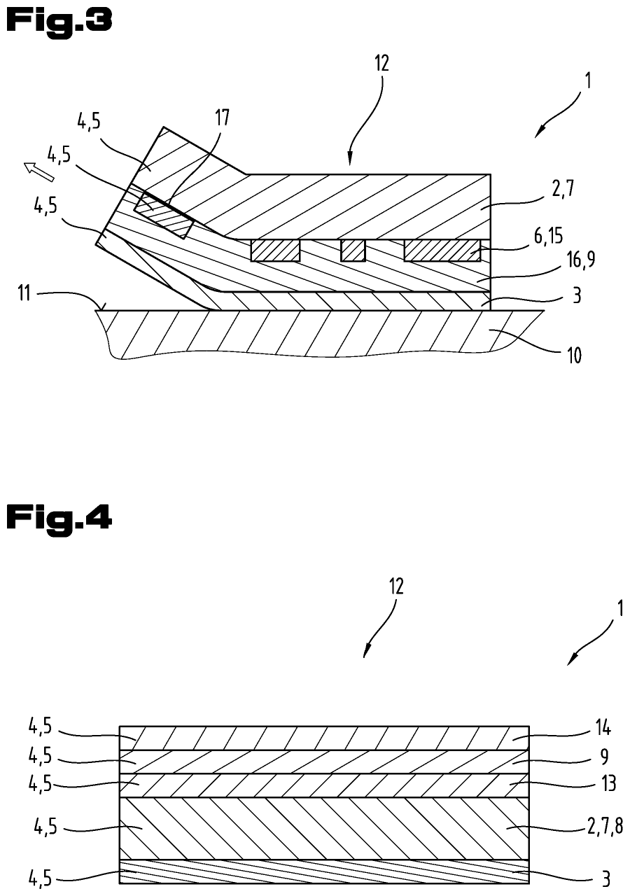

Depending on the type of adhesive element 1 with tamper evidence, detachment from the surface 11 may take place differently. Two detachment variants are outlined in FIGS. 2 and 3.

FIG. 2 shows that the carrier substrate 2 or the plastic film 7 is detached together with the partial separation layer 15 bonded on the carrier substrate 2, wherein, together with the partial separation layer 15, also areas of the layer 16 and the adhesive layer 3, disposed adjacent to the partial separation layer 15 and not covered over by the partial separation layer 15, are detached. This means that the layer 16 and the adhesive layer 3 separate during removal or that the layer 16 and the adhesive layer 3 partially tear during removal. The areas of the adhesive layer 15 disposed under the partial separation layer 3 and the layer 16 remain on the object 10.

By removing or detaching the carrier substrate 2, a pattern or the like formed by the partial separation layer 15 becomes visible to an observer. This is how the viewer recognizes that the object 10 has been tampered with.

Alternatively to the representation according to FIG. 2, it would also be conceivable that the adhesive layer 3 remains completely or at least largely completely on the surface 11 of the object 10, so that when the carrier substrate 2 is detached, the partial separation layer 16 and the adjacent areas of the layer 15 that are not covered over by the partial release layer 15 are detached. However, this variant is not shown figuratively.

It would also be conceivable, that the carrier substrate 2 or the plastic film 7 are detached together with the areas of the layer 16 and the adhesive layer 3 adjacent to the partial separation layer 15, so that the partial separation layer 15 remains together with the areas of the layer 16 and the adhesive layer 3 on the surface 11 of the object 10. This variant is also not shown figuratively.

FIG. 3 shows a variant in which the adhesive effect of the adhesive layer 3 with respect to the surface 11 of the object 10 is less pronounced, so that the entire adhesive element 1 may be removed without residue or at least largely without residue. During the detachment, an air gap 17 may build between the partial separation layer 15 and the carrier substrate 2. By creating this air gap 17, a pattern or the like formed by the partial separation layer 15 may become visible to an observer.

The adhesive element 1 shown in FIGS. 1 to 3 may be produced with at least 70% PCR material, preferably with at least 90% PCR content.

FIGS. 1 to 3 are described below largely in a synopsis to avoid unnecessary repetition.

The adhesive element 1 comprises a carrier substrate 2 and an adhesive layer 3 disposed at the carrier substrate 2. By means of this adhesive layer 3, the adhesive element 1 can be applied on the surface 11 of an object 10. The adhesive element 1 comprises at least one recycled material 4, and/or at least one material made from renewable raw materials, and/or at least one biologically degradable and/or marine-degradable material 5.

The adhesive element 1 may comprise at least one security feature, or at least one security element 6 with at least one security feature, according to the exemplary embodiment shown. In the example shown, the adhesive element 1 is configured by a security element 15 configured as a partial separation layer 6.

The carrier substrate 2 may be, for example, a cellulose fiber based substrate or, as in the embodiment example shown, a polymer-based substrate, such as a plastic film 7. The carrier substrate 2 may be covered with at least one plastic film 7 comprising the at least one recycled material 4 and/or the at least one material made of renewable raw materials and/or the at least one biologically degradable and/or marine-degradable material 5.

It goes without saying that the depiction of the figures is only to be interpreted roughly. Thus the security element 6 or the partial separation layer 15 is shown in FIGS. 1 to 3 with a rectangular cross-section, wherein the skilled person is of course aware of a large number of possible special embodiments, which will not be discussed in more detail here.

The security element 6 is arranged under the carrier substrate 2 in the exemplary embodiment shown in FIGS. 1 to 3. However, it is also conceivable that the security element or elements 6 are partially or fully embedded in the carrier substrate 2. In addition, the security element or elements 6 could also be applied under the carrier substrate 2 not directly as outlined, but spaced by one or more intermediate layers. The carrier substrate 2 and also the security element or elements 6 may also be covered or covered over by one or more further layers, partially or completely. For example, layers such as protective varnishes, heat-sealing varnishes, adhesives, etc. may be applied. These layers may also comprise at least one recycled material 4, and/or at least one material made of renewable raw materials, and/or at least one biologically degradable and/or marine-degradable material 5. For example, the recycled material 4 may be in the form of a recycled paint or recycled paint components in a layer, for example a protective layer. It is also conceivable that the paint or at least paint components comprise renewable raw materials.

It has proven to be expedient here that the adhesive element 1 comprises at least 10%, preferably at least 20%, particularly preferably at least 30%, in particular at least 50% of the at least one recycled material 4 and/or the at least one material made of renewable raw materials and/or the at least one biologically degradable and/or marine-degradable material 5. However, it is also possible that the adhesive element 1 comprises at least 20%, particularly preferably at least 30%, in particular at least 50% of several different recycled materials and/or several materials made of renewable raw materials and/or several biologically degradable and/or marine-degradable materials.

As already described, the adhesive elements shown in FIGS. 1 to 3 comprise 1 at least one recycled material 4 and/or at least one material made of renewable raw materials, and/or at least one biologically degradable and/or marine-degradable material 5. The recycled material 4 and/or the at least one material made of renewable raw materials 5 may be included in all components of the adhesive element 1, i.e. for example in the security elements 6 or security features and in the carrier substrate 2, in the adhesive layer 3 or in a further layer, for example in the protective layer. Of course, it does not always have to be the same material. For example, the security element 6 may have recycled aluminum content, while the carrier substrate 2 is at least partially made of recycled plastic, or vice versa. The components may comprise at least 10%, preferably at least 20%, particularly preferably at least 30%, in particular at least 50% of the at least one recycled material 4. The material made of renewable raw materials or the biologically degradable and/or marine-degradable material 5 may in principle be the same material as the recycled material 4.

For this purpose, the recycled material 4 comprised in the adhesive element 1, for example in the security elements 6 or in the carrier substrate 2, and/or the at least one material made of renewable raw materials and/or the at least one biologically degradable and/or marine-degradable material 5 is a cellulose fiber free material.

The at least one recycled material 4 comprised in the adhesive elements 1, in particular the carrier substrate 2, and/or the at least one biologically degradable and/or marine-degradable material 5 may comprise a chemically recycled plastic and/or a mechanically recycled plastic. In particular, it may comprise a translucent recycled plastic, wherein the at least one recycled material 4 is preferably at least one of the materials selected from the group consisting of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC), ethylene tetrafluoroethylene (ETFE), polytetrafluoroethylene (PTFE), polyvinyl fluoride (PVF), polyvinylidene fluoride (PVDF), ethylene tetrafluoroethylene hexafluoropropylene fluorterpolymer (EFEP), cellulose or lignin-based plastics, polyhydroxyalkanoates (PHA), thermoplastic starch (TPS), polylactic acid (PLA), polycaprolactone (PCL), polybutylene succinate (PBS), and polybutylene adipate terephthalate (PBAT) and/or mixtures and/or co-polymers and/or composites of these materials or is made from at least one of these materials.

The at least one recycled material 4 and/or the at least one biologically degradable and/or marine-degradable material 5 may be at least one recycled metallic material, in particular selected from the group consisting of silver, copper, aluminum, gold, platinum, niobium, tin, or nickel, titanium, vanadium, chromium, cobalt and palladium or alloys of these materials, in particular cobalt-nickel alloys, and/or at least one highly refractive dielectric material with a refractive index greater than 1.65, in particular selected from the group consisting of zinc sulphide (ZnS), zinc oxide (ZnO), titanium dioxide (TiO2), carbon (C), indium oxide (In2O3), indium tin oxide (ITO), tantalum pentoxide (Ta2O5), cerium oxide (CeO2), yttrium oxide (Y2O3), europium oxide (Eu2O3), iron oxides such as iron (II, III) oxide (Fe3O4) and iron (III) oxide (Fe2O3), hafnium nitride (HfN), hafnium carbide (HfC), hafnium oxide (HfO2), lanthanum oxide (La2O3), magnesium oxide (MgO), neodymium oxide (Nd2O3), praseodymium oxide (Pr6O11), samarium oxide (Sm2O3), antimony trioxide (Sb2O3), silicon carbide (SiC), silicon nitride (Si3N4), silicon monoxide (SiO), selenium trioxide (Se2O3), tin oxide (SnO2), tungsten trioxide (WO3), highly refractive organic monomers and/or highly refractive organic polymers or layers of metal oxides, such as non-stoichiometric aluminum oxide, copper oxides, or chromium oxides and/or be produced from at least one recycled metallic material from printing inks or varnishes with metallic pigments, in particular selected from the group of aluminum, silver, copper, gold, platinum, niobium, tin, or from nickel, titanium, vanadium, chromium, cobalt and palladium or alloys of these materials, in particular cobalt-nickel alloys.

The security features included in the illustrated security element 6 may be realized, for example, by an embossed layer, a partial metallized layer, a fluorescent layer, a printed layer, a magnetic coding and/or an optically variable and/or optically effective feature, in particular by a hologram and/or a color shifting coating, for example a coating comprising at least one color shifting thin-film element, and/or by features that are optically recognizable in transmission or reflection, machine-readable features and/or by electromagnetic wave-absorbing and/or re-emitting substances or features.

The adhesive element 1 shown in FIGS. 1 to 3 may be configured as a self-adhesive adhesive element 1, wherein the adhesive element 1, in particular the carrier substrate 2 or the plastic film 7, may comprise a PET film, which PET film is produced with at least 30% PCR material, preferably with at least 50% PCR material.

The adhesive element 1 shown in FIGS. 1 to 3 may, for example, also be configured as an adhesive element 1 with tamper evidence, i.e. as a so-called VOID label, which is produced with at least 70% PCR material, preferably with at least 90% PCR content.

FIG. 4 shows a further exemplary embodiment of an adhesive element 1. In order to avoid unnecessary repetition, reference is made to the detailed description for FIGS. 1 and 3.

FIG. 4 shows a further exemplary embodiment of an adhesive element 1 with a plastic film 7, wherein the plastic film 7 is configured as a metallized PE film 8. This metallized PE film 8 has a metallic layer 9 and is made with at least 20% PCR material, preferably with at least 50% PCR content. The metallized PE film 8 shown in FIG. 4 may also be produced with PCR material and PIR material in a ratio of at least essentially 1:1.

The metallic layer 9 may be at least one recycled metallic material, in particular selected from the group consisting of silver, copper, aluminum, gold, platinum, niobium, tin, or nickel, titanium, vanadium, chromium, cobalt and palladium or alloys of these materials, in particular cobalt-nickel alloys, and/or at least one highly refractive dielectric material with a refractive index of greater than 1.65, in particular selected from the group consisting of zinc sulphide (ZnS), zinc oxide (ZnO), titanium dioxide (TiO2), Carbon (C), indium oxide (In2O3), indium tin oxide (ITO), tantalum pentoxide (Ta2O5), cerium oxide (CeO2), yttrium oxide (Y2O3), Europium oxide (Eu2O3), iron oxides such as iron (II, III) oxide (Fe3O4) and iron (III) oxide (Fe2O3), hafnium nitride (HfN), hafnium carbide (HfC), hafnium oxide (HfO2), lanthanum oxide (La2O3a), magnesium oxide (MgO), neodymium oxide (Nd2O3), praseodymium oxide (Pr6O11), samarium oxide (Sm2O3), antimony trioxide (Sb2O3), silicon carbide (SiC), silicon nitride (Si3N4), silicon monoxide (SiO), selenium trioxide (Se2O3), tin oxide (SnO2), tungsten trioxide (WO3), highly refractive organic monomers and/or highly refractive organic polymers or layers of metal oxides, such as non-stoichiometric aluminum oxide, copper oxides, or chromium oxides and/or be produced from at least one recycled metallic material from printing inks or varnishes with metallic pigments, in particular selected from the group of aluminum, silver, copper, gold, platinum, niobium, tin, or from nickel, titanium, vanadium, chromium, cobalt and palladium or alloys of these materials, in particular cobalt-nickel alloys.

The adhesive element 1 shown in FIG. 4 has the following layers when viewed from the bottom layer, i.e. from the adhesive layer 3 in the direction of the visible side 12: an adhesive layer 3, a carrier substrate 2 made of a plastic film 7, in particular a PE film 8, a varnish layer 13 as an adhesion promoter layer, a metal layer 9 applied, in particular directly, to the varnish layer 13, and a cover layer 14. In principle, all layers or components may comprise at least one recycled material 4, and/or at least one material made of renewable raw materials, and/or at least one biologically degradable and/or marine-degradable material 5.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present disclosure lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be taken from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

1. Adhesive element, comprising a carrier substrate and an adhesive layer arranged on the carrier substrate, wherein the adhesive element comprises at least one recycled material, and/or at least one material made of renewable raw materials, and/or at least one biologically degradable and/or marine-degradable material.

2. Adhesive element according to claim 1, wherein the adhesive element comprises at least one security feature, or at least one security element with at least one security feature.

3. Adhesive element according to claim 2, wherein the security feature and/or the security element comprises the at least one recycled material, and/or the at least one material made of renewable raw materials, and/or the at least one biologically degradable and/or marine-degradable material.

4. Adhesive element according to claim 1, wherein the adhesive element comprises at least 10%, preferably at least 20%, more preferably at least 30%, in particular at least 50% of the at least one recycled material and/or the at least one material made of renewable raw materials and/or the at least one biologically degradable and/or marine-degradable material, or that the adhesive element comprises at least 10%, preferably at least 20%, particularly preferably at least 30%, in particular at least 50% of several recycled materials and/or several materials made of renewable raw materials and/or several biologically degradable and/or marine-degradable materials.

5. Adhesive element according to claim 1, wherein the at least one recycled material, and/or the at least one material made of renewable raw materials, and/or the at least one biologically degradable and/or marine-degradable material is a cellulose fiber free material.

6. Adhesive element according to claim 1, wherein the adhesive element, in particular the carrier substrate, is configured with at least one plastic film or as a plastic film, which plastic film comprises the at least one recycled material and/or the at least one material made of renewable raw materials and/or the at least one biologically degradable and/or marine-degradable material.

7. Adhesive element according to claim 1, wherein the at least one recycled material and/or the at least one biologically degradable and/or marine-degradable material comprises a chemically recycled plastic and/or a mechanically recycled plastic, in particular comprises a translucent recycled plastic, wherein the at least one recycled material and/or the at least one biologically degradable and/or marine-degradable material preferably comprises at least one material from the group consisting of polyimide (PI), polypropylene (PP), monoaxially oriented polypropylene (MOPP), biaxially oriented polypropylene (BOPP), polyethylene (PE), polyphenylene sulfide (PPS), polyether ether ketone (PEEK), polyether ketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC), ethylene tetrafluoroethylene (ETFE), polytetrafluoroethylene (PTFE), polyvinyl fluoride (PVF), polyvinylidene fluoride (PVDF), ethylene-tetrafluoroethylene-hexafluoropropylene fluorterpolymer (EFEP), cellulose or lignin-based plastics, polyhydroxyalkanoates (PHA), thermoplastic starch (TPS), polylactic acid (PLA), polycaprolactone (PCL), polybutylene succinate (PBS), and polybutylene adipate terephthalate (PBAT) and/or mixtures and/or co-polymers and/or composites of these materials or is made from at least one of these materials.

8. Adhesive element according to any of the preceding claims, characterized in that claim 1, wherein the at least one recycled material and/or the at least one biologically degradable and/or marine-degradable material is at least one recycled metallic material, in particular selected from the group consisting of silver, copper, aluminum, gold, platinum, niobium, tin, nickel, titanium, vanadium, chromium, cobalt and palladium or alloys of these materials, in particular cobalt-nickel alloys, copper, aluminum, gold, platinum, niobium, tin, or nickel, titanium, vanadium, chromium, cobalt and palladium or alloys of these materials, in particular cobalt-nickel alloys, and/or at least one highly refractive dielectric material with a refractive index of greater than 1.65, in particular selected from the group comprising zinc sulphide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), europium oxide (Eu₂O₃), iron oxides such as iron (II, III) oxide (Fe₃O₄) and iron (III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), high refractive index organic monomers and/or high refractive index organic polymers or layers of metal oxides, such as non-stoichiometric aluminum oxide, copper oxides, or chromium oxides and/or of at least one recycled metallic material from printing inks or varnishes with metallic pigments, in particular selected from the group consisting of aluminum, silver, copper, gold, platinum, niobium, tin, or nickel, titanium, vanadium, chromium, cobalt and palladium or alloys of these materials, in particular cobalt-nickel alloys.

9. Adhesive element according to claim 2, wherein the at least one security feature is provided by an embossed layer, a partially metallized layer, a fluorescent layer, a printed layer, a magnetic coding and/or an optically variable and/or optically effective feature, in particular by a hologram and/or a color shifting coating, for example a coating comprising at least one color shifting thin layer element, and/or by features that are optically recognizable in transmission or reflection, machine-readable features and/or by electromagnetic wave-absorbing and/or re-emitting substances or features.

10. Adhesive element according to claim 1, wherein the adhesive element is configured as a self-adhesive adhesive element, and in that the adhesive element, in particular the carrier substrate, comprises a PET film, which PET film is produced with at least 30% PCR material, preferably with at least 50% PCR material.

11. Adhesive element according to claim 6, wherein the plastic film is configured as a metallized PE film, which metallized PE film has a metal layer, wherein the metallized PE film is produced with at least 20% PCR material, preferably with at least 50% PCR content.

12. Adhesive element according to claim 6, wherein the plastic film is configured as a metallized PE film, which metallized PE film has a metal layer, the metallized PE film being produced with PCR material and PIR material in a ratio of at least substantially 1:1.

13. Adhesive element according to claim 1, wherein the adhesive element is an adhesive element with tamper evidence, which is produced with at least 70% PCR material, preferably with at least 90% PCR content.
